(19) United States
(12) Patent Application Publication
(10) Pub. No.: US 2013/0061732 A1
(43) Pub. Date: Mar. 14, 2013

(54) MULTI-PROFILE DIE CUTTING ASSEMBLY

(71) Applicants: Jeffrey W. Fritz, Plymouth, WI (US); Robert E. Andrews, Sheboygan, WI (US)

(72) Inventors: Jeffrey W. Fritz, Plymouth, WI (US); Robert E. Andrews, Sheboygan, WI (US)

(73) Assignee: Curt G. Joa, Inc., Sheboygan Falls, WI (US)

(21) Appl. No.: 13/414,431

(22) Filed: Mar. 7, 2012

Related U.S. Application Data
(60) Provisional application No. 61/450,917, filed on Mar. 9, 2011.

(51) Int. Cl. B26D 1/22

(52) U.S. Cl. 83/673

(57) ABSTRACT

A die roll is disclosing have multiple alternating patterns. Cutting edges and non-cutting edges on the die roll are phased with cutting surfaces and relieved areas on the anvil, respectively. Multiple cut profiles are achieved from a single die/anvil combination.

### RELATED APPLICATION

This application claims the benefit of co-pending U.S. Provisional Patent Application Ser. No. 61/450,917, filed 9 Mar. 2011.

### BACKGROUND OF THE INVENTION

The present invention relates to disposable hygiene products and more specifically, to methods and apparatuses for processing disposable hygiene products. More specifically, the invention relates to cutting and applying segments of one web to attach to a disposable diaper. Various types of automatic manufacturing equipment have been developed which produce the desired results with a variety of materials and configurations.

When manufacturing hygiene products, such as baby diapers, adult diapers, disposable undergarments, incontinence devices, sanitary napkins and the like, a common method of applying discrete pieces of one web to another is by use of a slip-and-cut applicator. A slip-and-cut applicator is typically comprised of a cylindrical rotating vacuum anvil, a rotating knife roll, and a transfer device. In typical applications, an incoming web is fed at a relatively low speed along the vacuum face of the rotating anvil, which is moving at a relatively higher surface speed and upon which the incoming web is allowed to “slip”. A knife-edge, mounted on the rotating knife roll, cuts a off a segment of the incoming web against the anvil face. This knife-edge is preferably moving at a surface velocity similar to that of the anvil's surface. Once cut, the web segment is held by vacuum drawn through holes on the anvil's face as it is carried at the anvil's speed downstream to the transfer point where the web segment is transferred to the traveling web.

Typical vacuum rolls used in the prior art have rows of vacuum holes which are fed by cross-drilled ports, each being exposed to the source of vacuum by commutations, as the ports move into a zone of negative pressure in a stationary manifold. Such a configuration serves to apply vacuum sequentially to each successive row of holes.

A common problem associated with slip-and-cut applicators occurs at the point of cut. Since the web being cut is traveling at a very low velocity compared to the anvil and knife velocity (perhaps 1/20th), the engagement of the knife with infeeding web tends to induce a high tensile stress in the infeeding web. Having been placed under such a high level of stress, the infeeding web can recoil violently when the cut is finally completed, causing loss of control of the infeeding web. This “snap-back” effect increases with the thickness of the infeeding web. Thicker webs tend to prolong the duration of engagement with the knife before completion of the cut, thereby increasing the build-up of stress. This is a common process problem that is usually addressed by the provision of various shock-absorbing devices. One possible solution might have been to reduce the surface velocity of the knife, but substantially different velocities between the knife and anvil result in rapid wear of the knife edge and/or anvil face, depending on relative hardness.

Continual improvements and competitive pressures have incrementally increased the operational speeds of disposable diaper converters. As speeds increased, the mechanical integrity and operational capabilities of the applicators had to be improved accordingly.

Slip-and-cut apparatus are well known for their ability to cut relatively short segments of one web and place them accurately on another, higher speed web. Certain materials, however, behave badly in these applications. The tension pulsation caused by the cutting may cause the material to snap back, losing its natural track down the moving surface of the anvil roll. This is especially common with thick webs. Other materials, such as nonwoven fabrics, may be difficult to control because they are very porous and provide little resistance to air flow to keep the material on track. Still other materials, such as certain perforated films may possess texture qualities which tend to be very unstable on the anvil surface, acting instead like a puck on an air hockey table.

These problems are further exacerbated by using materials with a very low modulus of elasticity. Here, even very low levels of vacuum at the anvil surface may cause the material to stretch with the advancing movement of the anvil. The sudden change of tension seen when the knife cuts this over-stretched web can result in severe snap-back and complete loss of position, relative to the intended centerline. Likewise, webs with very high moduli may snap back violently when the web is cut.

The prior art is quite successful when processing full-width or symmetrical webs, which are drawn uniformly forward by the sliding vacuum surface on which they are held. Attempts to process asymmetrical webs on such a surface are less successful, as the draw of the advancing vacuum pattern will act differently on parts of the web which have differing lines of tension. For instance, a die-cut ear web for a disposable diaper may have only a narrow continuous portion along one edge, with the opposite edge being more or less scalloped in shape.

Current die designs allow for only one cut profile per die/anvil combination. It would be desirable for multiple cut profiles to be possible with a single die/anvil combination.

### SUMMARY OF THE INVENTION

By providing multiple patterns on a die roll and phasing a non-cutting edge to a relieved area on the anvil, multiple cut profiles are achieved from a single set of tooling. It is therefore an object of this invention to provide an apparatus which can maintain control over die cut web sections of various shapes.

Longer or shorter ear profiles could also be created by varying material feed rate.

In a typical configuration of an ear cutting die/anvil combination, there is a pattern of vacuum holes distributed to evenly draw the entering web onto the anvil's surface and thence into a cut point where a knife edge engages an anvil, thus severing the web into discrete segments if so desired. The invention provides a generally cylindrical anvil body connected to a source of vacuum. The anvil roll has a plurality of ear retaining portions on its outer surface. This ear retaining portion is formed with a plurality of vacuum holes. The anvil roll is utilized in connection with a rotary multi pattern die to cut small segments of an incoming web. The anvil roll then transfers those cut segments to an additional web.

### BRIEF DESCRIPTION OF THE DRAWINGS

FIG. 1 is a perspective view of a multi-pattern die of the present invention;

FIG. 2 is a perspective view of a vacuum anvil of the present invention;

FIG. 3 is a side view of the die/anvil roll of the present invention;

FIG. 4 is a perspective view of the anvil roll of the present invention, with possible cutting zones delineated;

FIG. 5 is a plan view of a shaped ear profile cut by one of the pattern options of the die of the present invention;

FIG. 6 is a plan view of a square ear profile cut by one of the pattern options of the die of the present invention;

FIG. 7 is a plan view of shaped ear die phasing of a die of the present invention;

FIG. 8 is a plan view of square ear die phasing of a die of the present invention;

FIG. 9 is a side view of a square ear die cutting sequence, with a straight blade contacting a straight blade cutting surface;

FIG. 10 is a side view of a square ear die cutting sequence during rotation, with a curved blade meeting a recessed curved non-cutting channel;

FIG. 11 is a side view of a beginning of a phase change between a square ear die cutting sequence and a shaped ear cutting sequence;

FIG. 12 is a side view following of a phase change between a square ear die cutting sequence and a shaped ear cutting sequence, with a straight blade meeting a recessed straight non-cutting channel;

FIG. 13 is a side view of a shaped ear die cutting sequence, with a shaped blade contacting a shaped blade cutting surface;

FIG. 14 is a side view of a shaped ear die cutting sequence during rotation, with a straight blade meeting a recessed straight non-cutting channel;

FIG. 15 is a side view of a beginning of a phase change between a shaped ear die cutting sequence and a straight ear cutting sequence;

FIG. 16 is a side view following of a phase change between a between a shaped ear die cutting sequence and a straight ear cutting sequence, with a curved blade meeting a recessed curved non-cutting channel.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

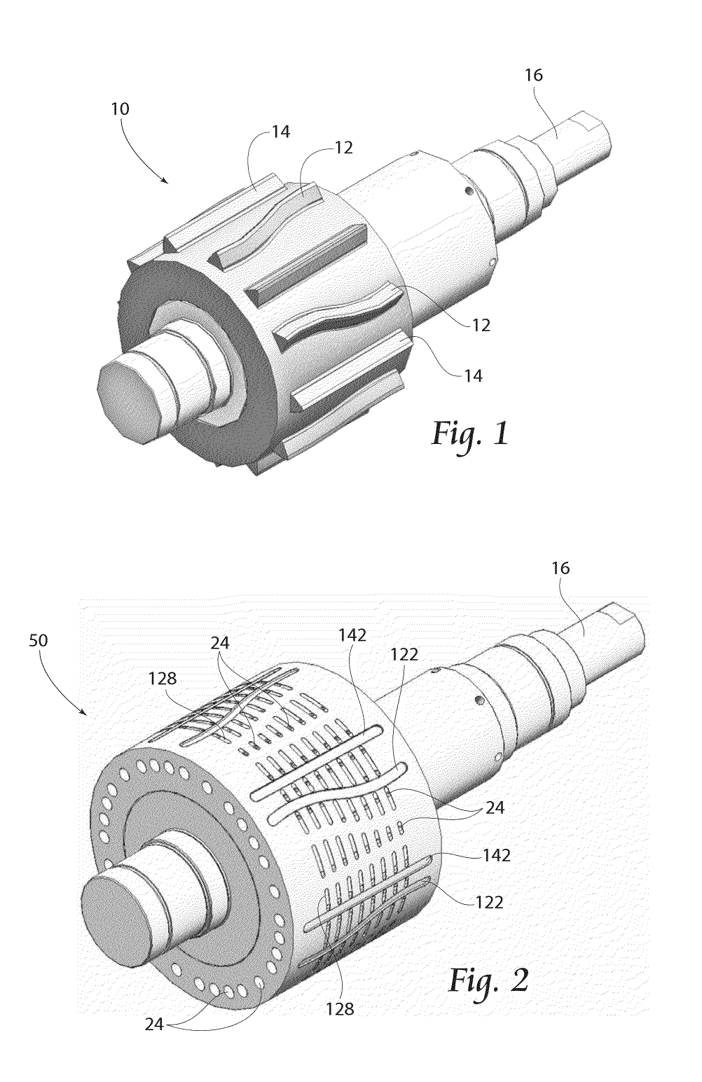

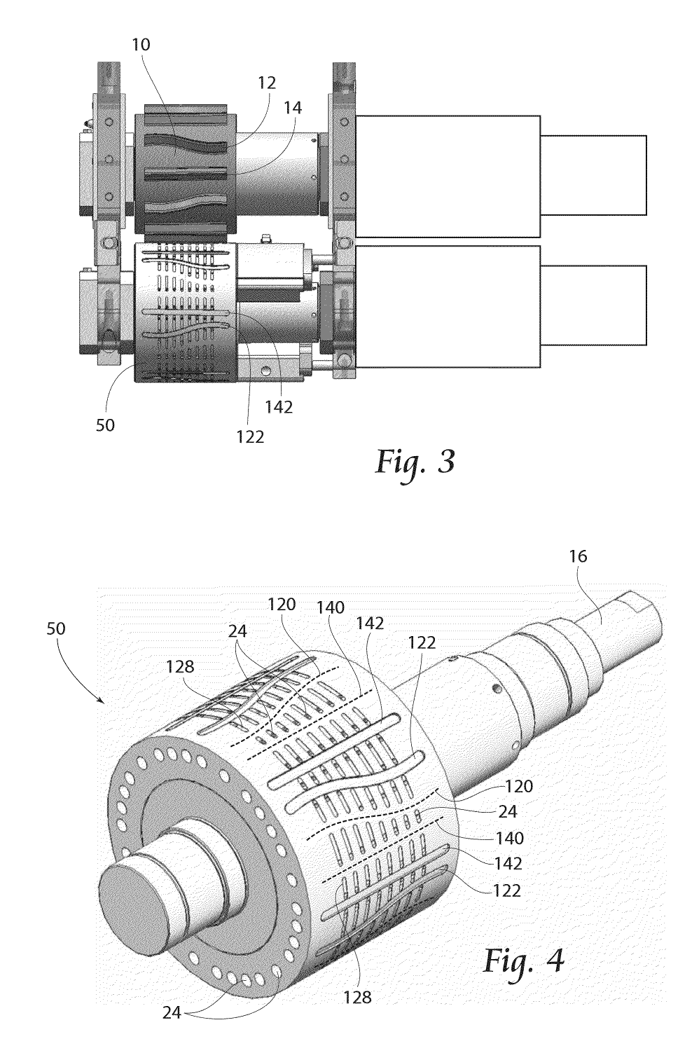

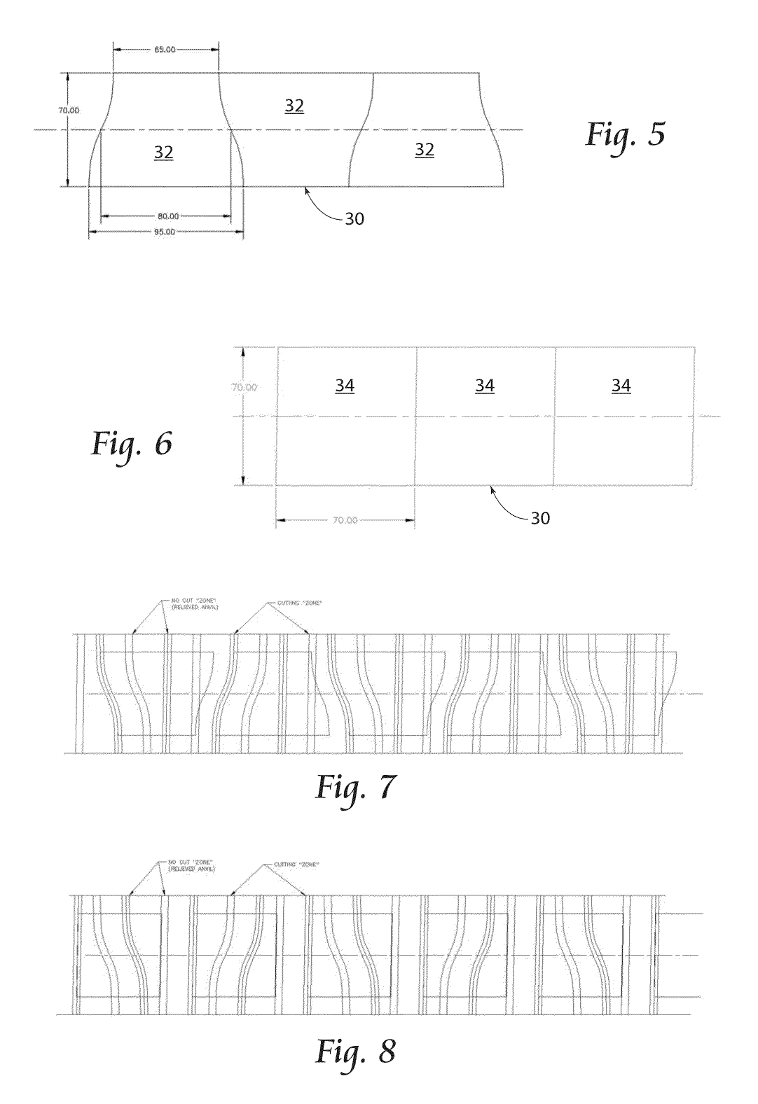

Referring now to FIG. 1, a perspective view of a multi-pattern die 10 of the present invention is shown. The die 10 is rotated by shaft 16 (preferably servo-motor driven, shown diagrammatically to the right of the die 10 and anvil 50 on FIG. 3) and blades, both curved blades 12, and straight blades 14, can be used in cooperation with a complimentary vacuum anvil 50 (FIG. 2) to sever portions of an incoming web (see, e.g., FIGS. 5 and 6) into any shape of ear pattern.

It is noted that the die 10 as shown in FIG. 1 comprises alternating cutting shapes, between curved, straight, and complimentary curved, straight, curved, etc. By providing multiple patterns on a die roll and phasing a non-cutting edge to a relieved area on the anvil (FIG. 2), multiple cut profiles can be achieved from a single set of tooling. An infinite number of varying cut patterns can be provided on the die 10 to provide different cut profiles.

Referring now to FIG. 2, a perspective view of a rotatable vacuum anvil 50 of the present invention is shown. When a curved ear pattern is desired (e.g., FIG. 5), curved blades 12 are employed against outer surfaces of the anvil 50, while the straight blades 14 are unemployed because they will be matched up with recessed portions 142 of the anvil 50 and therefore ineffectual.

When a straight ear pattern is desired (e.g., FIG. 6), straight blades 14 are employed against outer surfaces of the anvil 50, while the curved blades 12 are unemployed because they will be matched up with recessed portions 122 of the anvil 50 and therefore ineffectual.

The vacuum anvil 50 is driven by shaft 50 (preferably servo motor driven) and has vacuum commutation ports 24 to couple with a source of vacuum (not shown) during selected periods of rotation to apply vacuum to the radial surface ports 24 in shaped channels or vacuum slots 128. The radial surface ports apply vacuum to secure ear web material (shown later) to the surface of the vacuum anvil 50 during rotation of the vacuum anvil 50.

Referring now to FIGS. 2 and 3, several patterns are evident on the radial surface of the vacuum anvil 50 to interact with the cutting blades 12 and 14 of the multi pattern die 10. First, a series of recessed straight non-cutting channels 142 and recessed curved non-cutting channels 122 are shown on the vacuum anvil 50, which can loosely receive mated cutting blades 12 and 14 of the multi pattern die 10 during operation.

Referring to FIG. 4, a perspective view of the vacuum anvil roll 50 of the present invention is shown. Curved cutting surfaces 120, and straight cutting surfaces 140 are possible cutting zones delineated. In use, an operator will select between a plurality of possible cutting patterns, for instance the curved (shaped) ear pattern 32 formed from web 30 as shown in FIG. 5, or the straight pattern 34 shown in FIG. 6. The multiple patterns as shown in FIGS. 5 and 6 are a result of the multiple blade patterns of the die 10 as shown in FIG. 1.

If a curved or shaped ear pattern 32 is desired (FIG. 5), the anvil/die combination will be phased such that the curved blades 12 of the die 10 are aligned with the curved cutting surfaces 120 of the anvil 50. This will result, because of the complimentary shaping of the blades 12 and 14 with the recessed curved and straight non-cutting channels 122 and 142, respectively, in the straight blades 14 being loosely mated in the recessed straight non-cutting channels 142. No cut is effectuated in the web 30 by the straight blades 14 in the area of the loose mating of the straight blades 14 and the recessed straight non-cutting channels 142, because the blades 14 do not have a surface on the vacuum anvil on which to contact to force a cut against. During manufacture of the curved or shaped ear pattern 32, it is noted that the recessed curved non-cutting channel will remain unoccupied.

If a straight ear pattern 34 is desired (FIG. 6), the anvil/die combination will be phased such that the straight blades 14 of the die 10 are aligned with the straight cutting surfaces 140 of the anvil 50. This will result, because of the complimentary shaping of the blades 12 and 14 with the recessed curved and straight non-cutting channels 122 and 142, respectively, in the curved blades 12 being loosely mated in the recessed curved non-cutting channels 122. No cut is effectuated in the web 30 in the area of the loose mating of the curved blades 12 and the recessed curved non-cutting channels 122, because the blades 12 do not have a surface on the vacuum anvil on which to contact to force a cut against.

Referring now to FIGS. 7 and 8, plan views of shaped ear die phasing of a die of the present invention, and square ear die phasing of a die of the present invention are shown, respectively.

The shaped ear die phasing as shown in FIG. 7 corresponds with the formation of shaped ears, in which the curved blades 12 of the die 10 are aligned with the curved cutting surfaces 120 of the anvil 50. The straight blades 14 loosely mate in the recessed straight non-cutting channels 142, where no cut is effectuated in the web 30 by the straight blades 14.

The square ear die phasing as shown in FIG. 8 corresponds with the formation of square ears, in which the straight blades 14 of the die 10 are aligned with the straight cutting surfaces 140 of the anvil 50. The curved blades 11 loosely mate in the recessed curved non-cutting channels 122, where no cut is effectuated in the web 30 by the curved blades 12.

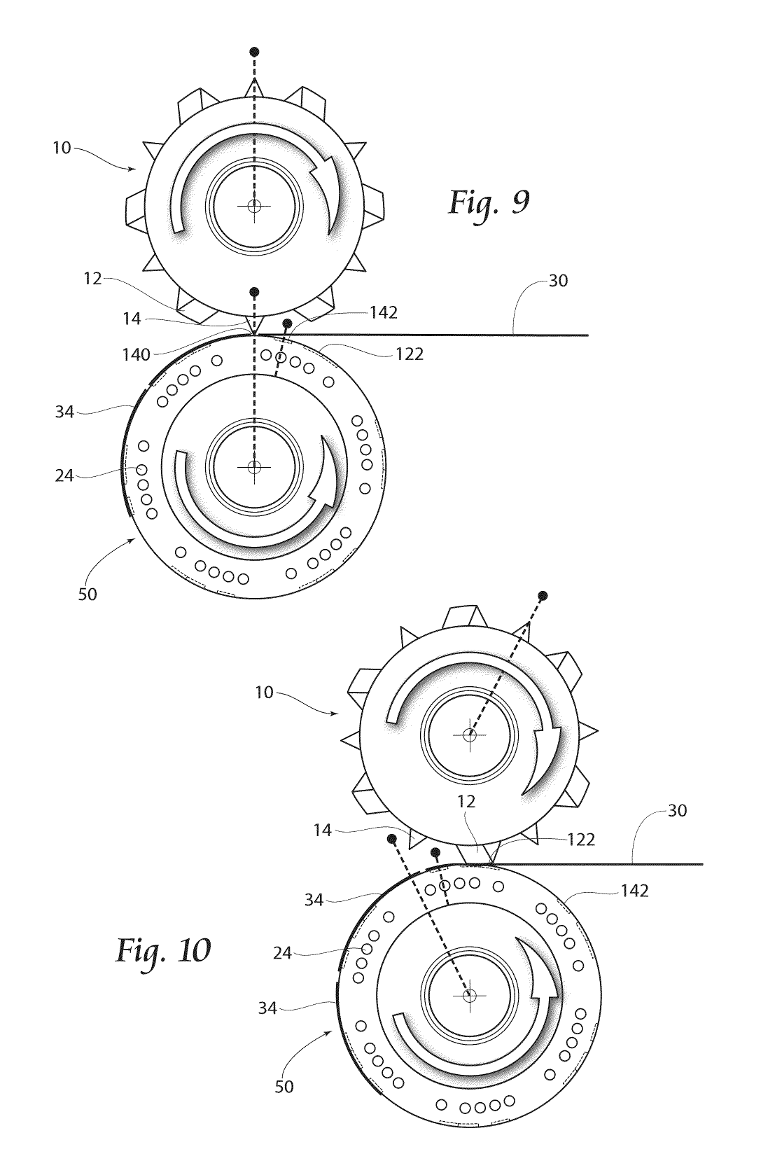

Referring now to FIG. 9, a side view of a square ear die cutting sequence is shown, with a straight blade 14 contacting a straight blade cutting surface 140 to cut the incoming web 30. Continuing through rotation, FIG. 10 shows a side view of the square ear die cutting sequence with a curved blade 12 meeting a recessed curved non-cutting channel 122, where no cut in the web 30 will be effectuated. Square ears 34 are shown departing the sequence, carried rotationally by the anvil 50, and in particular by the vacuum commutation ports 24 until picked up by downstream processing apparatus as desired (not shown).

Referring now to FIG. 11, a side view of a beginning of a phase change between a square ear die cutting sequence and a shaped ear cutting sequence is shown. If a user desires to manufacture shaped ears 32, this phase change can be initiated.

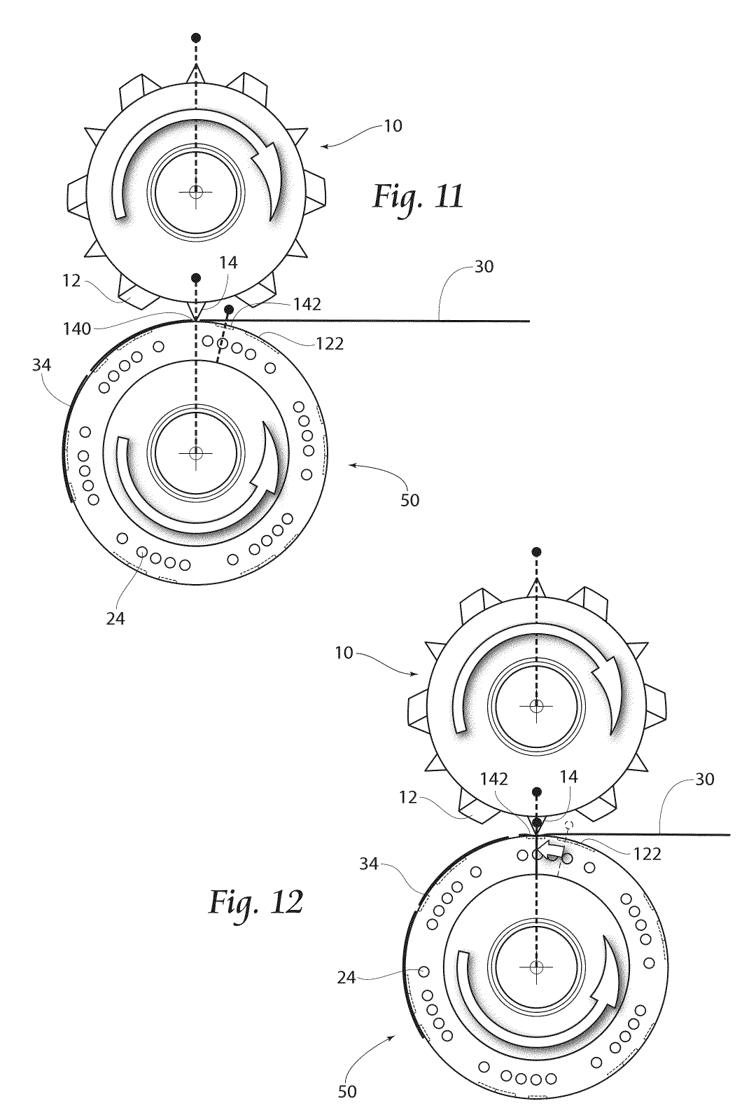

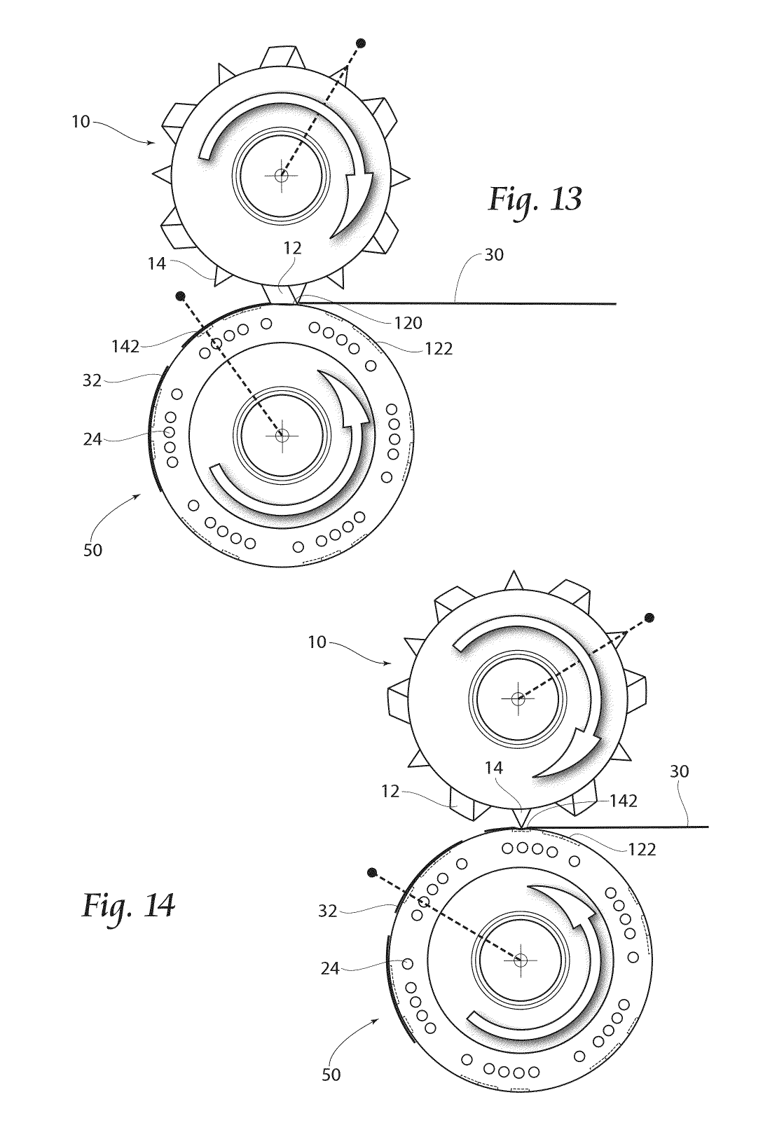

As shown in FIG. 12, after a phase change between a square ear die cutting sequence and a shaped ear cutting sequence, the straight blades 14 will no longer meet the straight cutting surfaces 140, but instead will meet a recessed straight non-cutting channel 142, where no cut is effectuated. Conversely, as shown in FIG. 13, during the shaped ear die cutting sequence, shaped blades 12 contact the shaped blade cutting surfaces 120 and as shown in FIG. 14 the straight blades 14, acting in a non-cutting manner, meet their respective recessed straight non-cutting channels 142.

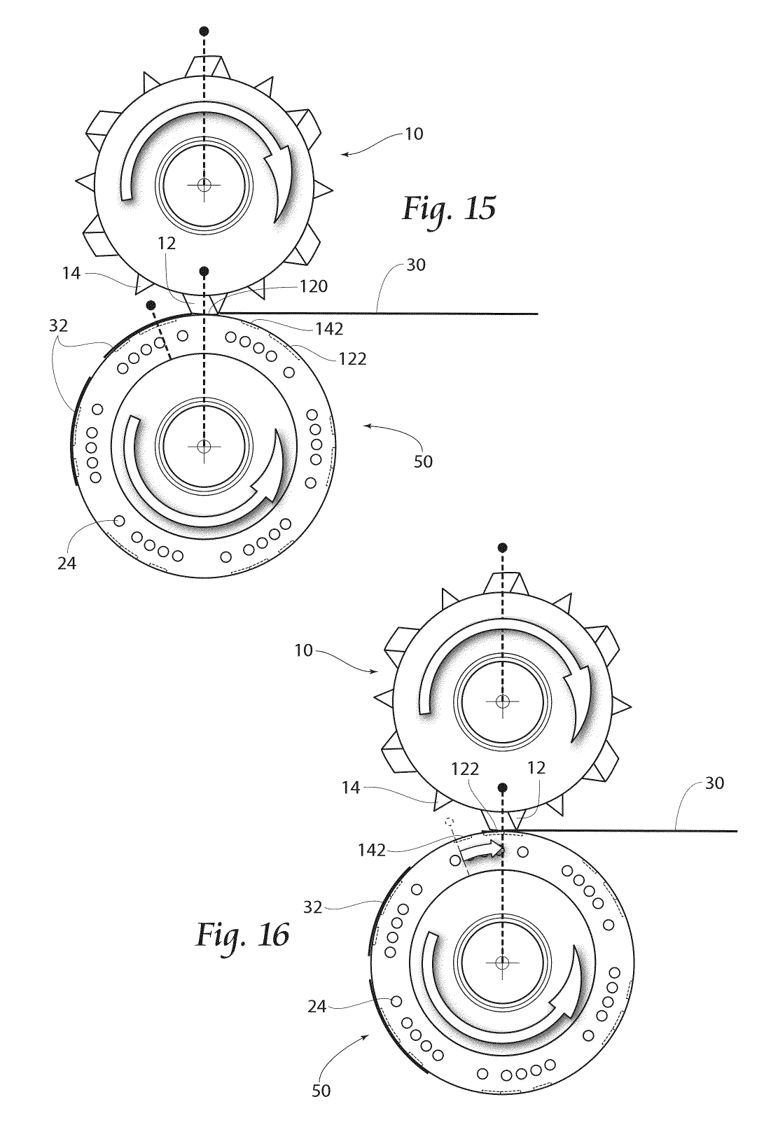

FIGS. 15 and 16 show a reversion of the phases, from a shaped ear die cutting sequence to the straight ear cutting sequence, where once again the curved blades 12 meet the recessed curved non-cutting channels 122, and the straight blades 14 meet the straight cutting surfaces 140.

It is noted that the invention has been described in relation to alternating straight and curved patterns, but that alternating patterns of any type (curved, straight, contoured, angled, patterned, etc) can be used, even alternating identical patterns.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. A die/anvil combination comprising:
a die comprising a series of die edges;
an anvil comprising a first die edge receiving channel and a first die edge contacting surface, said channel selectively receiving said first die edge, and said first die edge contacting surface also selectively receiving said first die edge.

2. A die/anvil combination according to claim 1, said series of die edges arranged in alternating pairs of complementary edges.

3. A die/anvil combination according to claim 1, every other die edge being curved.

4. A die/anvil combination according to claim 1, every other die edge being straight.

5. A die/anvil combination according to claim 1, said anvil comprising a second die edge receiving channel and a second die edge contacting surface, said first channel receiving said first die edge while said second die edge contacting surface receiving said first die edge.
